(19) United States
(12) Patent Application Publication
(10) Pub. No.: US 2002/0129632 A1
(43) Pub. Date: Sep. 19, 2002

(54) Concentrated phosphorus fertilizer

(76) Inventors: Colin Sheppardson, Norfork (GB); Charles D. Tarbell, Visalia, CA (US)

Correspondence Address: Daniel J. Meaney, Jr., Post Office Box 22307, Santa Barbara, CA, 93121, US

(21) Appl. No.: 09/810,776

(22) Filed: Mar. 15, 2001

(51) Int. Cl. C05C 1/00

(52) U.S. Cl. 71/27

(57) ABSTRACT

A concentrated fluid phosphorus fertilizer is shown. In the preferred embodiment, the concentrated fluid phosphorus fertilizer is an aqueous suspension fertilizer composition. The composition comprises one or more phosphorus-containing acids or salts thereof selected from the group consisting of phosphoric acid, polyphosphoric acid, phosphorous acid, polyphosphorous acid, hypophosphorous acid and polyhypophosphorous acid, and salts thereof. A suspension agent maintains undissolved solids in substantially homogeneous suspension wherein the suspension has a total acid and salt content of about 50% w/w to about 80% w/w. The concentrated fluid phosphorus fertilizer is a stable suspension and when diluted with water a substantially fully soluble fertilizer having acceptable pH for phosphorus uptake is formed. Methods for improving the phosphorus uptake and improving the growth rate of plants is also shown.

### CROSS-REFERENCES TO RELATED APPLICATIONS

Not Applicable

### STATEMENT REGARDING FEDERALLY SPONSORED RESEARCH OR DEVELOPMENT

Not Applicable

### REFERENCE TO A “MICROFICHE APPENDIX” (SEE 37 CFR 1.96)

Not Applicable

### BACKGROUND OF THE INVENTION

1. Field of the Invention

The present invention relates to a inorganic phosphorus fertilizer and fertilizer compositions, generally and specifically to a concentrated fluid phosphorus fertilizer in a form which will absorb quickly into plant systems and when the concentrated phosphorus fertilizer is diluted with water, a substantially fully soluble fertilizer having acceptable pH for phosphorus uptake is formed. This invention also relates to concentrated phosphorus suspension fertilizer compositions and method for preparing such compositions.

In addition, this invention also relates to a method for improving the phosphorus uptake of plants and a method of improving the growth rate of plants.

2. Description of the Prior Art

It is known in the art to use fertilizers to supply the nutritional needs of plants. Fertilizer are known to comprise three basic elements, namely nitrogen, phosphorus and potassium. Fertilizers may also contain a variety of micronutrients to supplement the requirements of plants for trace elements.

Many of the phosphorus fertilizers have a number of limitations. If the phosphorus fertilizer is not used right away, the fertilizer when prepared in concentrated solutions tend to form participates. The fertilizer must be maintained within a narrow pH range to prevent precipations. Further, in order for the plants to assimilate phosphorus, the fertilizer must contain soluble materials.

Elemental phosphorus does not exist in nature and the principal source of phosphorus for use in fertilizers is the ores of phosphorus-containing minerals. Phosphorus-containing minerals are typically processed to provide phosphorus fertilizers which make phosphorus available in the form of phosphate (PO₄³⁻), hydrogen phosphate (HPO₄²⁻), dihydrogen phosphate (H₂PO₄₋) or phosphoric acid (H₃PO₄) for uptake by plants.

Phosphorus may also be made available for uptake by plants in the form of phosphite (PO₃³⁻), hydrogen phosphite (HPO₃²⁻), dihydrogen phosphite (H₂PO₃₋) or phosphorous acid (H₃PO₃). The use of phosphorous acid and its salt forms as a fertilizer is described, for example, in Fertilizer Research, 32, 161-168 (1992).

The use of phosphites in fertilizers is also discussed in U.S. Pat. No. 5,800,837 (Taylor) which describes application to plants of a solution of phosphate (phosphoric acid) salts and a solution of phosphite (phosphorous acid) salts.

Concentrated phosphorus fertilizers are known in the art. For example U.S. Pat. Nos. 5,514,200, 5,830,253 and 6,113,665, issued to Lovett, disclose concentrated phosphorus fertilizers having phosphorus in a more readily absorbable form of PO₃⁻³ in a composition buffered with an organic acid.

In addition, U.S. Pat. Nos. 5,707,418 and 5,864,418, issued to Hsu, disclose a concentrated phosphorus fertilizer of the phosphorus variety comprising phosphorous acid or hypophosphorous acid, or salts thereof, and a polyphosphoric acid complexing agent which are absorbed quickly into plant systems and comprise a compound having an inorganic complexing agent or salts thereof. In U.S. Pat. No. 5,707,418, the inorganic complexing agent or salts thereof comprise at least 1% less than 30% by weight of the concentrated phosphorus fertilizer formulation. U.S. Pat. No. 5,864,418 requires greater phosphorus uptake by the plant treated with the phosphorus compound to be greater than if an equivalent amount of phosphite or phosphate were used alone, a performance level which may be difficult to determine or evaluate.

Although fertilizers can be applied to fields in solid form, it is environmentally preferred that phosphorus-containing fertilizers are applied in solution form. This facilitates better targeting of the fertilizer to the plants as well as minimizing wastage of fertilizer and unnecessary run-off of phosphate into groundwater. Solution formulations of fertilizers can, for example, be targeted directly to the roots of plants via irrigation systems and are particularly required for fertilizers for foliar application, where application of a tightly controlled relatively dilute dose is required.

For transportation of fertilizers, however, it is desirable to minimize the volume and weight of the fertilizer formulation. Although transportation of fertilizers in solid form is most efficient, this requires dissolution of the fertilizer, requiring provision of mixing apparatus, at the point of use.

The solubility of phosphoric acid, polyphosphoric acid, phosphorous acid, polyphosphorous acid, hypophosphorous acid and polyhypo-phosphorous acid, and salts thereof is limited. Accordingly, conventional solution formulations of phosphorus-containing fertilizers often suffer from problems of crystallization, precipitation and settling, and/or must be provided in sufficiently dilute concentration to avoid such problems.

Fertilizers in suspension form typically suffer from settling, which makes handling difficult and again requires provision of mixing apparatus at the point of use.

Accordingly, there remains a need for a phosphorus-containing fertilizer that can be transported in concentrated form and easily diluted at the point of use to provide a fertilizer in solution form.

### BRIEF SUMMARY OF THE INVENTION

The present invention seeks to overcome the disadvantages of the prior art by providing a concentrated phosphorus fertilizer for improving the phosphorus uptake of plants and improving the growth rate of plants.

In the light of the above-mentioned problems with conventional fertilizer formulations and the requirements of fertilizers in general, the present invention teaches a novel and unique concentrated phosphorus fertilizer in the form of a liquid wherein the phosphorus is in a soluble form so as to be easily absorbed by plant materials.

Therefore, it is an advantage of the present invention to provide a concentrated suspension formulation of a phosphorus-containing fertilizer that can be readily diluted at the point of use for application to plants.

One advantage of the present invention is that the concentrated phosphorus fertilizer is a stable suspension and when the concentrated phosphorus fertilizer is diluted with water, a substantially fully soluble fertilizer having acceptable pH for phosphorus uptake is formed.

Another advantage of the present invention is that the concentrated phosphorus fertilizer, when diluted, has a pH of from 5.0 to about 7.5.

Another advantage of the present invention is that the concentrated phosphorus fertilizer includes a suspension agent for preventing mono potassium phosphate in suspension from settling out of the fertilizer.

Another advantage of the present invention is that the concentrated phosphorus fertilizer includes a suspension agent for preventing mono potassium phosphate in suspension from settling out of the fertilizer wherein the suspension agent is selected from the group consisting of polysaccharides, galactomannans, anionic polymers, cationic polymers and non-ionic polymers.

Another advantage of the present invention is that a method of improving the phosphorus uptake of plants comprising application of a water diluted concentrated phosphorus fertilizer to plants is taught.

Another advantage of the present invention is that a method of improving the growth rate of plants comprising application of a water diluted concentrated phosphorus fertilizer to plants is taught.

Another advantage of the present invention is to provide a concentrated suspension formulation of a phosphorus-containing fertilizer that is substantially homogenous and does not suffer from settling, and can be poured into a suitable container for dilution prior to use.

Another advantage of the present invention is to provide a concentrated suspension formulation of a fertilizer that requires no mixing or other preparation for use on site other than dilution with water.

Another advantage of the present invention is to provide a concentrated suspension formulation of a fertilizer comprising both phosphoric acid or a salt thereof and phosphorous acid or a salt thereof that can be readily diluted at the point of use for application to plants.

Another advantage of the present invention is to provide a concentrated suspension formulation of a fertilizer comprising both phosphoric acid or a salt thereof and phosphorous acid or a salt thereof that is substantially homogenous and does not suffer from settling, and can be poured into a suitable container for dilution prior to use.

Another advantage of the present invention is to provide a concentrated suspension formulation of a fluid fertilizer comprising both phosphoric acid or a salt thereof and phosphorous acid or a salt thereof that requires no mixing or other preparation for use on site other than dilution with water.

In the light of the above advantages and features, the present invention in the preferred embodiment provides an aqueous suspension fertilizer composition comprising a) one or more phosphorus-containing acids or salts thereof selected from the group consisting of phosphoric acid, polyphosphoric acid, phosphorous acid, polyphosphorous acid, hypophosphorous acid and polyhypo-phosphorous acid, and salts thereof; and b) a suspension agent for maintaining undissolved solids in substantially homogeneous suspension; wherein the suspension composition has a total acid and salt content of about 50% w/w to about 80% w/w.

In another embodiment, the present invention provides an aqueous suspension fertilizer composition comprising a) phosphoric acid or a salt thereof, b) phosphorous acid or a salt thereof; and c) a suspension agent for maintaining undissolved solids in substantially homogeneous suspension; wherein the suspension composition has a total acid and salt content of about 50% w/w to about 80% w/w.

In another embodiment, the concentrated phosphorus fertilizer comprises a mono potassium phosphite comprising about 50% w/w of the fertilizer, an EDTA zinc comprising about 0.2% zinc by weight of the fertilizer, an EDTA manganese comprising about 0.29% manganese by weight of the fertilizer wherein the EDTA zinc and the EDTA manganese are substantially dissolved and substantially saturate the mono potassium phosphite resulting in a absence of water for additional dissolving, a mono potassium phosphate which is in suspension in the fertilizer, and a suspension agent for preventing mono potassium phosphate in suspension from settling out of the fertilizer. The concentrated phosphorus fertilizer is a stable suspension and when the concentrated phosphorus fertilizer is diluted with water, a substantially fully soluble fertilizer having acceptable pH for phosphorus uptake is formed.

### BRIEF DESCRIPTION OF THE DRAWING

The present invention will become more fully understood from the following detailed description of a preferred but non limiting embodiment thereof, described in connection with the accompanying drawings, wherein:

FIG. 1 is a flow diagram of a method for improving the phosphorus uptake of plants comprising the steps of: (i) providing a mono potassium phosphite; (ii) mixing an EDTA Zinc into the mono potassium phosphite forming a mixture; (iii) mixing an EDTA manganese into the mixture; (iii) mixing a mono potassium phosphate into the mixture wherein the mono potassium phosphate is in suspension; (iv) mixing into the mixture a suspension agent for preventing the mono potassium phosphate in suspension from settling out of the mixture forming a concentrated liquid fertilizer; and (v) diluting the concentrated liquid fertilizer with water to form a substantially fully soluble fertilizer having a foliage-acceptable pH for phosphorus uptake and applying the diluted fertilizer to the plants; and

FIG. 2 is a schematic representation of the step of diluting the concentrated liquid fertilizer to have a pH of from 5.0 to about 7.5.

### DETAILED DESCRIPTION OF THE INVENTION

The present invention relates to a fully soluble concentrated phosphorus fertilizer, to a method of making a concentrated phosphorus fertilizer, to a method of improving the phosphorus uptake of plants and a method for improving the growth rate of plants.

The present invention provides a highly concentrated phosphorous-containing fertilizer in a substantially homogeneous suspension.

The suspension fertilizer composition of the present invention is economical to transport (being highly concentrated) is easy to measure out and dilute at the point of use (being liquid and pourable, and being substantially homogenous such that stirring of the suspension prior to dilution is not required). Moreover, being in liquid suspension form, dilution with water is easily achieved without sophisticated mixing apparatus.

The suspension comprises a phosphorous-containing acid or salt thereof selected from the group consisting of phosphoric acid, polyphosphoric acid, phosphorous acid, polyphosphorous acid, hypophosphorous acid and polyhypophosphorous acid.

Preferably, the suspension fertilizer composition of the present invention comprises phosphorous acid or a salt thereof, or phosphoric acid or a salt thereof, or a mixture thereof.

More preferably, the suspension fertilizer comprises about 15% w/w to about 75% w/w phosphorous acid or a salt thereof. Additionally or alternatively, the suspension fertilizer comprises about 5% w/w to about 55% w/w phosphoric acid or a salt thereof.

Any suitable salt form of a phosphorus-containing acid may be used in the present invention including potassium, ammonium and sodium salts. Preferably, the salts comprise potassium or ammonium salts. In a preferred embodiment, the suspension fertilizer comprises monopotassium phosphite (KH₂PO₃) and monopotassium phosphate (KH₂PO₄). Preferably, the suspension fertilizer comprises about 15% w/w to about 75% w/w monopotassium phosphite and from about 5% w/w to about 55% w/w monopotassium phosphate.

It will be appreciated, however, that phosphorus-containing acids are polybasic acids. Accordingly, the acids and their salt forms will exist in equilibrium, the position of the equilibrium depending upon the pH. For example KH₂PO₄ (monopotassium phosphate) will exist in equilibrium with H₃PO₄, K₂HPO₄ and K₃PO₄. Whilst at a given pH one species may predominate, the other species will also be present. Similarly, KH₂PO₃ (monopotassium phosphite) will exist in equilibrium with H₃PO₃, K₂HPO₃ and K₃PO₃.

In the present application reference to % w/w refers to percentage weight by weight.

The suspension fertilizer composition of the present invention may be diluted with water for use at a ratio of about 1:10 to about 1:1000, preferably about 1:40 to about 1:100. Dilution of the suspension composition preferably provides a clear solution with no undissolved solids. Dilution of the suspension fertilizer preferably provides a solution having a pH acceptable for direct application to plants without any need to adjust the pH. Preferably, the suspension has a pH of about 4.0 to about 7.0. Preferably, dilution provides a solution having a pH of about 5.0 to about 7.5, more preferably about 5.5 to about 6.5.

The suspension agent may comprise any agent which maintains undissolved solids in substantially homogenous suspension. By “substantially homogenous suspension” it is meant that there is no significant settlement of the suspension. Suitable suspension agents include thickening agents capable of maintaining the viscosity suspension at from about 15,000 to about 24,000 cp, preferably about 19,000 to about 20,000 cp (determined using a Brookfeid LVTD viscosity meter spindle 3 at 25° C.)

Preferred suspension agents include polysaccharides including celluloses such as carboxy methyl cellulose and cellulose xanthate, starches and their chemical derivatives such as those obtained by esterification and oxidation, galactomannans, such as hydroxy propyl guar, hydroxyethyl guar carboxymethyl guar, man-made polymers including anionic polymers such as polyactrylamides and their derivatives, cationic polymers, such as co-polymers of acrylamide and non-ionic polymers such as polyois, polyethers and polyamides, for example polyvinyl alcohol.

Preferred suspension agents include polysaccharides. The term polysaccharides includes modified polysaccharides. Examples of suitable polysaccharides include alkyl celluloses (such as ethylmethylcellulose and carboxy methyl cellulose), xanthan gum, and modified polysaccharides such as anionic heteropolysaccharides (such as modified xathan gum).

The concentrated phosphorus fertilizer may alternatively, include a suspension agent for preventing mono potassium phosphate in suspension from settling out of the fertilizer wherein the suspension agent is selected from the group consisting of polysaccharides, galactomannans, anionic polymers, cationic polymers and non-ionic polymers.

The suspension fertilizer compositions of the present invention may additionally comprise a source of nitrogen. Preferred sources of nitrogen include urea and nitrate salts including ammonium nitrate, potassium nitrate and sodium nitrate. Preferably the nitrogen source comprises urea or ammonium nitrate. The nitrogen source may comprise from 0% to a weight equal to or greater than that of the phosphorus-containing acid or salt in the suspension fertilizer composition.

The suspension fertilizer compositions of the present invention may additionally comprise sources of micronutrients such as calcium, magnesium, iron, copper, zinc, manganese, cobalt, selenium, boron, molybdenum, silicates and sulphur (sulfur). Sources of these micronutrients may each comprise up to about 7.5% of the suspension fertilizer composition. Iron, copper, zinc and manganese may be present in the form of chelates of these metals. Suitable chelating agents are well known to persons skilled in the art and include EDTA. Calcium and magnesium may be present in the form of chelates of these metals or in the form of salts of the metals. Suitable chelating agents are well known to persons skilled in the art and include EDTA. Suitable salts include nitrate and sulfate. Salts are generally preferable when the pH of the suspension is less that about pH4 and chelates are generally preferable when the pH is greater than about pH4. Boron may be present as boric acid. Molybdenum and sulphur (sulfur) may be present as required for a soil supplement (e.g., sodium or ammonium molybdate and as elemental sulphur).

It will be appreciated that other additives, commonly used in fertilizers and well known to those skilled in the art, may be present in the composition. Such additives include buffering agents, wetting agents, surfactants, spreaders, stickers, etc.

### Method of Preparation

The suspension fertilizer compositions of the present invention may be prepared by mixing a phosphorus-containing acid or a salt thereof and a suspension agent in an aqueous medium, with vigorous stirring to ensure formation of a substantially homogeneous suspension. Sufficient suspension agent is added to ensure formation of a gel of sufficient viscosity to maintain any undissolved solids in substantially homogeneous suspension.

Phosphorus-containing acids and salts thereof may be obtained from commercial sources or prepared in advance for mixing with the suspension agent. Alternatively, salts of phosphorus-containing acids may be prepared in situ. For example a mixture of phosphoric acid and/or phosphorous acid in water may be treated with a potassium carbonate prior to addition of a suspension agent.

Micronutrients, for example in the form of salts or EDTA complexes such as manganese EDTA and zinc EDTA, can be added at any time during preparation of the suspension fertilizer composition. It is preferred, however, to add them prior to the suspension agent, so as to ensure even distribution throughout the suspension.

In another embodiment, the concentrated phosphorus fertilizer comprises a mono potassium phosphite comprising about 50% w/w of the fertilizer. An EDTA zinc comprising about 0.2% zinc by weight of the fertilizer is mixed into the mono potassium phosphite forming a mixture. An EDTA manganese comprising about 0.2% manganese by weight of the fertilizer is added to the mixture. The EDTA zinc and the EDTA manganese are substantially dissolved and substantially saturate the mixture resulting in an absence of water for additional dissolving. A mono potassium phosphate is added to the mixture and the mono potassium phosphate is in suspension in the fertilizer. A suspension agent is added to the mixture for preventing mono potassium phosphate in suspension from settling out of the fertilizer. The resulting concentrated phosphorus fertilizer is a stable solution and when the concentrated phosphorus fertilizer is diluted with water, a substantially fully soluble fertilizer having acceptable pH for phosphorus uptake is formed.

### Methods of Use

A feature of the suspension fertilizer compositions of the present invention is that they are highly concentrated formulations and therefore very economic to transport. There are, however, also substantially homogenous fluid suspensions which can be poured and are therefore both easy to measure (by volume or by weight) and easy to dilute to the desired concentration. A further feature of the invention is that the suspension fertilizer composition is provided in a form that requires no mixing or other preparation at the point of use other than dilution.

The diluted fertilizer may be applied by conventional method to roots (for example by soil application or irrigation) or by foliar application (for example by spraying), the precise route of application, time of application and rate of application depending on the particular crop.

Crops to which the fertilizer may be applied include, but are not limited to avocado, citrus, mango, coffee, deciduous tree crops, grapes and other berry crops, soybean and other commercial beans, corn, tomato, cucurbits and cucumis species, lettuce, potato, sugar beets, peppers, sugarcane, hops, tobacco, pineapple, coconut palm, vegetable crops (such as cabbage and cauliflower), celery, peas and other commercial and ornamental palms, hevea rubber, and ornamental plants.

### EXAMPLES

The invention will now be described with reference to the following examples which are provided for illustration only and should not be construed as limiting on this spirit or scope of the present invention.

### Example 1

A formulation was prepared by mixing 585 lbs of aqueous mono potassium phosphite solution of analysis 0-28-19 (O—P₂O₅—K₂O) and 410 lbs of monopotassium phosphate in a high shear mixer for a period of 15 minutes. Five pounds of the suspension agent, xanthan gum was added and mixing continued for a period of 60 minutes to produce a gel of sufficient viscosity to maintain undissolved solids in suspension. The final suspension had an analysis of 0-37-25 (O—P₂O₅—K₂O) and a pH of 4.5.

Xanthan gum obtained from CP Kelco, Liverpool, UK, CAS Number 11138-66-2, EINICS Number 234-394-2 produced by culture fermentation from Xanthomonas campestris, purified by recovery with propan-2-ol. Xanthan gum used complied with the specification for xanthan gum in E.U.Council Directive 82/504/EEC, amending E.U.Council Directive 78/663/EEC, laying down specific criteria of purity for emulsifiers, stabilizers, thickeners and gelling agents for use in foodstuffs. Xanthan gum repeat units consist of 5 sugar residues (2 glucose, 2 mannose, and 1 glucuronic acid). The backbone consists of 1,4 linked β D-glucose and each trisaccharide side chain comprises a glucuronic acid residue between 2 mannose units. At most of the terminal mannose units there is a pyruvate moiety; the mannose nearest the main chain carries a single acetyl group at C-6. The xanthan gum was also sourced from Rhodia Chemie, Courbevoie, France).

### Example 2

A formulation was prepared by mixing 273 lbs of phosphorous acid (60% P₂O₅), 352 lbs of phosphoric acid (60% P₂O₅) and 91.2 lbs of water in a high shear mixer. 373 lbs of potassium carbonate (67% K₂O) was added, which increased the pH to 4.5, followed by addition of 15.4 lbs of manganese EDTA and 13.4 lbs of zinc EDTA. The mixture was allowed to cool to ambient temperature followed by addition of 3.5 pounds of a suspension agent (xanthan gum, as above) and water to give a total weight of 1000 lbs. The mixture was then mixed to produce a substantially homogeneous suspension.

### Example 3

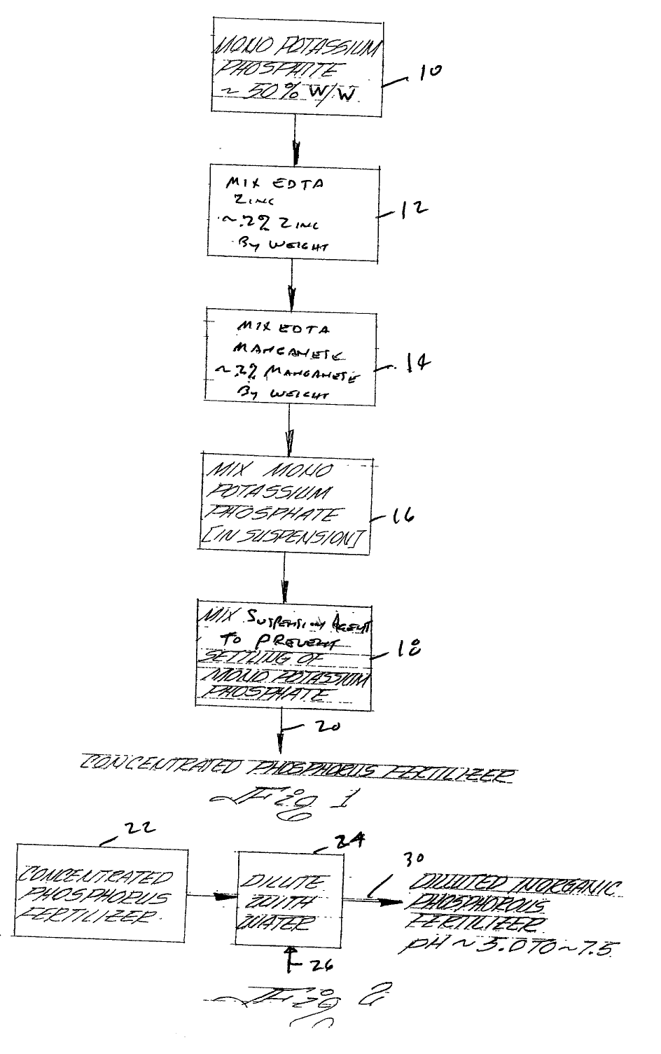

A method for making a concentrated phosphorus fertilizer is illustrated by the schematic diagram of FIG. 1. The first step is providing a mono potassium phosphite comprising about 50% w/w of the fertilizer as depicted by box 10 of FIG. 1. An EDTA zinc comprising about 0.2% zinc by weight of the fertilizer is added to the mono potassium phosphite as illustrated by box 12. An EDTA manganese comprising about 0.2% manganese by weight of the fertilizer is added as depicted by box 14. The EDTA zinc and the EDTA manganese are substantially dissolved and substantially saturate the mono potassium phosphite resulting in an absence of water for additional dissolving. The step of mixing a mono potassium phosphate to the mixture results in the mono potassium phosphate being in suspension in the fertilizer as depicted box 16. The next step is mixing of a suspension agent in the mixture for preventing mono potassium phosphate in suspension from settling out of the fertilizer as depicted by box 18. The resulting concentrated phosphorus fertilizer is represented by arrow 20 and is a stable solution.

FIG. 2 depicts that the concentrated phosphorus fertilizer depicted by box 22 of FIG. 2 is diluted with water as depicted by box 24 and the water is shown by arrow 26. After dilution with water 26, a substantially fully soluble fertilizer having acceptable pH for phosphorus uptake is formed as depicted by arrow 30 in FIG. 2.

The concentrated suspension formulation of a fertilizer comprises both phosphoric acid or a salt thereof and phosphorous acid or a salt thereof. As a result, fertilizer is substantially homogenous, does not suffer from settling, and is easily suitable for dilution prior to use. Further, the concentrated suspension formulation requires no mixing or other preparation for use on site other than dilution with water.

It will therefore be appreciated that the present invention provides a unique concentrated phosphorus fertilizer for improving the phosphorus uptake of plants and improving the growth rate of plants. The concentrated phosphorus fertilizer is a stable solution and when the concentrated phosphorus fertilizer is diluted with water, a substantially fully soluble fertilizer having acceptable pH for phosphorus uptake is formed A suspension agent is added to the concentrated phosphorus fertilizer for preventing the mono potassium phosphate, which is in suspension, from settling out of the fertilizer. This is important when holding vessels or tanks are used for applying the concentrated phosphorus fertilizer to plants as the suspension agents prevent the momo potassium phosphate from settling to the bottom of the holding vessel. There is a possibility that some of the mono potassium phosphate may be dissolved, but the amount thereof would be negligible.

In the preferred embodiment, the concentrated phosphorus fertilizer has utility as a foliar nutritional product. It is envisioned that the concentrated phosphorus fertilizer in substantially the preferred embodiment or a variation thereof may have utility as a pesticide. It will be appreciated that various alterations and modifications may be made to the concentrated phosphorus fertilizer to enhance the functional characteristics thereof. All such variations and modifications should be considered to fall within the scope of the invention as broadly hereinbefore described and as claimed hereafter.

All such uses, variations, modifications and the like are anticipated to be within the scope of this invention.

What is claimed is:

1. An aqueous suspension fertilizer composition comprising
one or more phosphorus-containing acids or salts thereof selected from the group consisting of phosphoric acid, polyphosphoric acid, phosphorous acid, polyphosphorous acid, hypophosphorous acid and polyhypophosphorous acid, and salts thereof, and
a suspension agent to maintain undissolved solids in substantially homogeneous suspension wherein the suspension has a total acid and salt content of about 50% w/w to about 80% w/w.

2. The aqueous suspension fertilizer composition of claim 1 wherein the phosphorus-containing acid or salt thereof comprises phosphorous acid or a salt thereof.

3. The aqueous suspension fertilizer composition of claim 2 wherein the phosphorus-containing acid or salt thereof comprises potassium phosphite.

4. The aqueous suspension fertilizer composition of claim 2 wherein the suspension composition comprises about 15% w/w to about 75% w/w phosphorous acid or a salt thereof.

5. The aqueous suspension fertilizer composition of claim 1 wherein the phosphorus-containing acid or salt thereof comprises phosphoric acid or a salt thereof.

6. The aqueous suspension fertilizer composition of claim 5 wherein the phosphorus-containing acid or salt thereof comprises monopotassium phosphate.

7. The aqueous suspension fertilizer composition of claim 5 wherein the suspension composition comprises about 5% w/w to about 55% w/w phosphoric acid or a salt thereof.

8. The aqueous suspension fertilizer composition of claim 1 wherein the phosphorus-containing acid or salt thereof comprises a mixture of phosphorous acid or a salt thereof and phosphoric acid or a salt thereof.

9. The aqueous suspension fertilizer composition of claim 8 wherein the aqueous suspension fertilizer composition of claim on composition comprises about 15% w/w to about 75% w/w potassium phosphite and about 5% w/w to about 55% w/w monopotassium phosphate.

10. The aqueous suspension fertilizer composition of claim 1 wherein the suspension agent is selected from the group consisting of alkyl celluloses and polysaccharides.

11. The aqueous suspension fertilizer composition of claim 10 wherein the suspension agent is an anionic heteropolysaccharide.

12. The aqueous suspension fertilizer composition of claim 10 wherein the suspension agent is xanthan gum.

13. The aqueous suspension fertilizer composition of claim 1 wherein the suspension composition additionally contains a nitrogen source.

14. The aqueous suspension fertilizer composition of claim 13 wherein the suspension composition contains a nitrogen source selected from the group consisting of urea and ammonium nitrate.

15. The aqueous suspension fertilizer composition of claim 1 wherein the suspension composition additionally contains one or more micronutrients.

16. The aqueous suspension fertilizer composition of claim 15 wherein the suspension composition additionally contains one or more micronutrients selected from the group consisting of calcium, magnesium, iron, copper, zinc, manganese, cobalt, selenium, boron, molybdenum, silicates and sulphur.

17. The aqueous suspension fertilizer composition of claim 16 wherein the suspension composition additionally contains manganese EDTA.

18. The aqueous suspension fertilizer composition of claim 16 wherein the suspension composition additionally contains zinc EDTA.

19. A concentrated phosphorus fertilizer comprising a mono potassium phosphite comprising about 50% w/w of the fertilizer;
an EDTA zinc comprising about 0.2% zinc by weight of the fertilizer;
an EDTA manganese comprising about 0.2% manganese by weight of the fertilizer wherein said EDTA zinc and said EDTA manganese are substantially dissolved and substantially saturate said mono potassium phosphite resulting in a absence of water for additional dissolving;
a mono potassium phosphate which is in suspension in the fertilizer; and
a suspension agent for preventing mono potassium phosphate in suspension from settling out of the fertilizer;
said concentrated phosphorus fertilizer being a stable solution and when said concentrated phosphorus fertilizer is diluted with water, a substantially fully soluble fertilizer having acceptable pH for phosphorus uptake is formed.

20. The concentrated phosphorus fertilizer of claim 19 wherein said fertilizer, when diluted, has a pH of from 5.0 to about 7.5.

21. The concentrated phosphorus fertilizer of claim 19 wherein said suspension agent is selected from the group consisting of polysaccharides, galactomannans, anionic polymers, cationic polymers and non-ionic polymers.

22. A concentrated phosphorus fertilizer formulation comprising
a phosphorus derived from a mono potassium phosphite comprising about 50% w/w of the fertilizer;
an EDTA zinc comprising about 0.2% zinc by weight of the fertilizer;
an EDTA manganese comprising about 0.2% manganese of the fertilizer wherein said EDTA zinc and said EDTA manganese are substantially dissolved and substantially saturate said mono potassium phosphite resulting in a absence of water for additional dissolving;
a mono potassium phosphate which is in suspension in the fertilizer; and
a suspension agent for preventing mono potassium phosphate in suspension from settling out of the fertilizer;
said concentrated phosphorus fertilizer formulation when diluted with water forming a substantially fully soluble fertilizer.

23. The concentrated phosphorus fertilizer formulation of claim 22 wherein said substantially fully soluble fertilizer has an acceptable pH for phosphorus uptake.

24. The concentrated phosphorus fertilizer formulation of claim 23 wherein said fertilizer formulation, when diluted with water, has a pH of about 5.0 to 7.5.

25. A method of improving the phosphorus uptake of plants comprising application of a water diluted concentrated phosphorus fertilizer of claim 19 to plants.

26. A method of improving the phosphorus uptake of plants comprising application of a water diluted concentrated phosphorus fertilizer formulation of claim 22 to plants.

27. A method of improving the growth rate of plants comprising application of a water diluted concentrated phosphorus fertilizer of claim 19 to plants.

28. A method of improving the growth rate of plants comprising application of a water diluted concentrated phosphorus fertilizer formulation of claim 22 to plants.

29. A method of improving the phosphorus uptake of plants comprising
providing a concentrated phosphorus fertilizer comprising a mono potassium phosphite comprising about 50% w/w of the fertilizer; an EDTA zinc comprising about 0.2% zinc by weight of the fertilizer; an EDTA manganese comprising about 0.2% manganese by weight of the fertilizer wherein said EDTA zinc and said EDTA manganese are substantially dissolved and substantially saturate said mono potassium phosphite resulting in a absence of water for additional dissolving;
mixing a mono potassium phosphate which is in suspension in the fertilizer;
mixing a suspension agent for preventing mono potassium phosphate in suspension from settling out of the fertilizer wherein said concentrated phosphorus fertilizer is a stable solution and when said concentrated phosphorus fertilizer is diluted with water, a substantially fully soluble liquid fertilizer having acceptable pH for phosphorus uptake is formed; and
diluting said concentrated liquid fertilizer with water to form a substantially fully soluble fertilizer having a foliage-acceptable pH for phosphorus uptake; and
applying said diluted fertilizer to said plants.

30. The method of improving the phosphorus uptake of plant of claim 29 wherein the step of diluting said concentrated liquid fertilizer includes using a fertilizer, when diluted, having a pH of from 5.0 to about 7.5.

31. The method of improving the phosphorus uptake of plant of claim 29 wherein the step of mixing a suspension agent includes using a suspension agent selected from the group consisting of polysaccharides, galactomannans, anionic polymers, cationic polymers and non-ionic polymers.

32. A method for making an inorganic phorphosus fertilizer comprising the steps of:
providing a mono potassium phosphite;
mixing an EDTA Zinc into the mono potassium phosphite forming a mixture;
mixing an EDTA manganeze into the mixture;
mixing a mono potassium phosphate into the mixture wherein the mono potassium phosphate is in suspension; and
mixing into the mixture a suspension agent for preventing the mono potassium phosphate in suspension from settling out of the mixture forming a concentrated liquid fertilizer.

33. The method for making an inorganic phorphosus fertilizer of claim 32 further comprising the step of:
diluting the concentrated liquid fertilizer with water to a substantially fully soluble fertilizer having a foliage-acceptable pH for phosphorus uptake.

34. The method for making an inorganic phorphosus fertilizer of claim 33 further comprising the step of:
applying the diluted substantially fully soluble fertilizer to plants.

35. A method of improving the phosphorus uptake of plants comprising application of a water diluted concentrated phosphorus fertilizer of claim 1 to plants.
